(19) United States
(12) Patent Application Publication
(10) Pub. No.: US 2026/0295416 A1
(43) Pub. Date: Oct. 1, 2026

(54) GAME APPARATUS, GAME SYSTEM, PROGRAM, AND VOLUME ADJUSTING METHOD

(71) Applicant: NINTENDO CO., LTD., Kyoto-shi (JP)

(72) Inventors: Hironori KAKEMIZU, Kyoto (JP); Jyunya OSADA, Kyoto (JP); Masato ONISHI, Kyoto (JP); Tatsuya MATSUMOTO, Kyoto (JP)

(21) Appl. No.: 19/447,884

(22) Filed: Jan. 13, 2026

(30) Foreign Application Priority Data
Mar. 28, 2025 (JP) 2025-056024

(51) Int. Cl. A63F 13/54; G06F 3/16

(52) U.S. Cl. CPC A63F 13/54; G06F 3/165

(57) ABSTRACT

Game apparatus includes obtainer configured to obtain, from game application, audio data and a plurality of volume parameters being set respectively for a plurality of audio output devices to which game apparatus outputs audio data, determiner configured to determine audio output target among the plurality of audio output devices, adjuster configured to adjust volume of audio data obtained by obtainer based on volume parameter corresponding to audio output target among the plurality of volume parameters, and output adjusted audio data to audio output target, and transmitter configured to transmit audio data and the plurality of volume parameters obtained by obtainer to other game apparatus.

### CROSS-REFERENCE TO RELATED APPLICATION

The disclosure of Japanese Patent Application No. 2025-056024, filed on Mar. 28, 2025, is incorporated herein by reference.

### BACKGROUND

The present disclosure relates to a game apparatus, a game system, a program, and a volume adjusting method.

### SUMMARY

The game apparatus, the game system, the program, and the volume adjusting method according to one or more aspects of the present disclosure may have, for example, structures (1) to (13) below.

### 1

A game apparatus according to an aspect of the present disclosure is the game apparatus for transmitting and receiving information about a game application to and from another game apparatus by executing the game application, the apparatus includes
an obtainer configured to obtain, from the game application, audio data and
a plurality of volume parameters being set respectively for a plurality of audio output devices to which the game apparatus outputs the audio data,
a determiner configured to determine an audio output target among the plurality of audio output devices,
an adjuster configured to adjust a volume of the audio data obtained by the obtainer based on a volume parameter corresponding to the audio output target among the plurality of volume parameters, and output the adjusted audio data to the audio output target, and
a transmitter configured to transmit the audio data and the plurality of volume parameters obtained by the obtainer to the other game apparatus.

In the structure (1), the game apparatus can adjust the volume of the audio data to the volume corresponding to the audio output target for the game apparatus based on the audio data and the volume parameters obtained from the game application to output the resulting audio data to the audio output target for the game apparatus.

In the structure (1), the game apparatus can transmit the audio data and the volume parameters to the other game apparatus with the transmitter. This allows the other game apparatus to adjust, in the same manner as the game apparatus, the volume of the audio data to output the resulting audio data to the audio output target for the other game apparatus.

### 2

In the structure according to (1), the game apparatus may include
a speaker and
an audio output terminal configured to output audio, wherein
the plurality of audio output devices may include the speaker and a connection device connected to the audio output terminal, and
the plurality of volume parameters may include a first parameter corresponding to the speaker and a second parameter corresponding to the connection device.

In the structure (2), the game apparatus can adjust the volume of the audio data to the volume corresponding to the speaker in the game apparatus based on the audio data and the first parameter obtained from the game application to output the resulting audio data to the speaker in the game apparatus.

In the structure (2), the game apparatus can adjust the volume of the audio data to the volume corresponding to the connection device connected to the audio output terminal in the game apparatus based on the audio data and the second parameter obtained from the game application to output the resulting audio data to the connection device.

In the structure (2), the game apparatus can transmit the audio data, the first parameter, and the second parameter to the other game apparatus with the transmitter. This allows the other game apparatus to adjust, in the same manner as the game apparatus, the volume of the audio data to output the resulting audio data to the speaker in the other game apparatus or to the connection device connected to the audio output terminal in the other game apparatus.

### 3

In the structure according to (1) or (2), the game apparatus may include
a speaker and
an image output terminal configured to output audio and an image,
wherein the plurality of audio output devices may include the speaker and an image display device connected to the image output terminal, and
the plurality of volume parameters may include a first parameter corresponding to the speaker and a third parameter corresponding to the image display device.

In the structure (3), the game apparatus can adjust the volume of the audio data to the volume corresponding to the speaker in the game apparatus based on the audio data and the first parameter obtained from the game application to output the resulting audio data to the speaker.

In the structure (3), the game apparatus can adjust the volume of the audio data to the volume corresponding to the image display device connected to the image output terminal in the game apparatus based on the audio data and the third parameter obtained from the game application to output the resulting audio data to the image display device.

In the structure (3), the game apparatus can transmit the audio data, the first parameter, and the third parameter to the other game apparatus with the transmitter. This allows the other game apparatus to adjust, in the same manner as the game apparatus, the volume to output the resulting audio data to the speaker in the other game apparatus or to the image display device connected to the image output terminal in the other game apparatus.

### 4

In the structure according to any one of (1) to (3),
the transmitter may convert the audio data obtained by the obtainer to data corresponding to the other game apparatus based on apparatus information obtained from the other game apparatus and may transmit the converted audio data to the other game apparatus.

When, for example, both the game apparatus and the other game apparatus include the speaker as an audio output destination but the speakers in the two apparatuses are of different types, the structure (4) allows the transmitter in the game apparatus to transmit audio data corresponding to the speaker in the other game apparatus to the other game apparatus.

### 5

In the structure according to any one of (1) to (4),
the obtainer may obtain, from the game application, image data and a plurality of image parameters being set respectively for a plurality of image output devices to which the game apparatus outputs the image data,
the determiner may determine an image output target among the plurality of image output devices,
the adjuster may adjust the image data obtained by the obtainer based on an image parameter corresponding to the image output target among the plurality of image parameters, and may output the adjusted image data to the image output target, and
the transmitter may transmit the image data and the plurality of image parameters obtained by the obtainer to the other game apparatus.

In the structure (5), the game apparatus can adjust the image data to an image corresponding to the image output target for the game apparatus based on the image data and the image parameters obtained from the game application to output the image data to the image output target for the game apparatus.

In the structure (5), the game apparatus can transmit the image data and the image parameters to the other game apparatus with the transmitter. This allows the other game apparatus to adjust, in the same manner as the game apparatus, the image data to output the image data to the image output target for the other game apparatus.

### 6

In the structure according to any one of (1) to (5),
the obtainer may obtain, from the game application, waveform data about vibrations of the game apparatus and a plurality of waveform parameters being set respectively for a plurality of waveform output devices to which the game apparatus outputs the waveform data,
the determiner may determine a waveform output target among the plurality of waveform output devices,
the adjuster may adjust the waveform data obtained by the obtainer based on a waveform parameter corresponding to the waveform output target among the plurality of waveform parameters, and may output the adjusted waveform data to the waveform output target, and
the transmitter may transmit the waveform data and the plurality of waveform parameters obtained by the obtainer to the other game apparatus.

In the structure (6), the game apparatus can adjust the waveform data to the waveform for the waveform output target for the game apparatus based on the waveform data and the waveform parameters obtained from the game application to output the waveform data to the waveform output target for the game apparatus.

In the structure (6), the game apparatus can transmit the waveform data and the waveform parameters to the other game apparatus with the transmitter. This allows the other game apparatus to adjust, in the same manner as the game apparatus, the waveform data to output the waveform data to the waveform output target for the other game apparatus.

### 7

A game system according to an aspect of the present disclosure includes
a plurality of game apparatuses configured to execute a game application and transmit and receive information to and from one another, each of the plurality of game apparatuses including
   an obtainer configured to obtain audio data and a plurality of volume parameters being set respectively for a plurality of audio output devices to which the plurality of game apparatuses output the audio data,
   a determiner configured to determine an audio output target among the plurality of audio output devices,
   an adjuster configured to adjust a volume of the audio data obtained by the obtainer based on a volume parameter corresponding to the audio output target among the plurality of volume parameters, and output the adjusted audio data to the audio output target, and
   a transmitter configured to transmit the audio data and the plurality of volume parameters to another game apparatus of the plurality of game apparatuses, the obtainer in a main apparatus being one of the plurality of game apparatuses including the game application, the obtainer in a main apparatus being configured to obtain the audio data and the plurality of volume parameters from the game application, and
the obtainer in a game apparatus of the plurality of game apparatuses other than the main apparatus being configured to obtain at least the audio data and the plurality of volume parameters transmitted by the transmitter in the main apparatus.

In the structure (7), the main apparatus can adjust the volume of the audio data to the volume corresponding to the audio output target for the main apparatus based on the audio data and the volume parameters obtained from the game application to output the resulting audio data to the audio output target for the main apparatus.

In the structure (7), the main apparatus can transmit the audio data and the volume parameters to the other game apparatus with the transmitter. The other game apparatus can adjust the volume of the audio data to the volume corresponding to the audio output target for the other game apparatus based on the audio data and the volume parameters obtained from the main apparatus to output the resulting audio data to the audio output target for the other game apparatus.

### 8

In the structure according to (7),
each of the plurality of game apparatuses may include
   a speaker, and
   an audio output terminal configured to output audio,
the plurality of audio output devices may include the speaker and a connection device connected to the audio output terminal, and
the plurality of volume parameters may include a first parameter corresponding to the speaker and a second parameter corresponding to the connection device.

In the structure (8), the main apparatus can adjust the volume of the audio data to the volume corresponding to the speaker in the main apparatus based on the audio data and the first parameter obtained from the game application to output the resulting audio data to the speaker in the main apparatus.

In the structure (8), the main apparatus can adjust the volume of the audio data to the volume corresponding to the connection device connected to the audio output terminal in the main apparatus based on the audio data and the second parameter obtained from the game application to output the resulting audio data to the connection device.

In the structure (8), the main apparatus can transmit the audio data, the first parameter, and the second parameter to the other game apparatus with the transmitter. The other game apparatus can adjust the volume based on the audio data, the first parameter, and the second parameter obtained from the main apparatus to output the resulting audio data to the speaker in the other game apparatus or to the connection device connected to the audio output terminal in the other game apparatus.

### 9

In the structure according to (7) or (8),
each of the plurality of game apparatuses may include
   a speaker, and
   an image output terminal configured to output audio and an image,
the plurality of audio output devices may include the speaker and an image display device connected to the image output terminal, and
the plurality of volume parameters may include a first parameter corresponding to the speaker and a third parameter corresponding to the image display device.

In the structure (9), the main apparatus can adjust the volume of the audio data to the volume corresponding to the speaker in the main apparatus based on the audio data and the first parameter obtained from the game application to output the resulting audio data to the speaker in the main apparatus.

In the structure (9), the main apparatus can adjust the volume of the audio data to the volume corresponding to the image display device connected to the image output terminal in the game apparatus based on the audio data and the third parameter obtained from the game application to output the resulting audio data to the image display device.

In the structure (9), the transmitter in the main apparatus can transmit the audio data, the first parameter, and the third parameter to the other game apparatus. The other game apparatus can adjust the volume based on the audio data, the first parameter, and the third parameter obtained by the obtainer from the main apparatus to output the resulting audio data to the speaker in the other game apparatus or to the image display device connected to the image output terminal in the other game apparatus.

### 10

In the structure according to any one of (7) to (9),
the game apparatus other than the main apparatus may not include the game application, and may obtain a game image associated with the game application from the main apparatus.

When the main apparatus alone includes the game application, the structure (10) allows the other game apparatus to obtain the game image associated with the game application from the main apparatus. The game application can thus be executed in all the game apparatuses.

### 11

In the structure according to any one of (7) to (10),
the transmitter in the main apparatus may convert the audio data to data corresponding to the game apparatus other than the main apparatus based on apparatus information obtained from the game apparatus other than the main apparatus, and may transmit the converted audio data to the game apparatus other than the main apparatus.

When, for example, both the main apparatus and the other game apparatus include a speaker as an audio output destination but the speakers in the two apparatuses are of different types, the structure (11) allows the transmitter in the main apparatus to transmit audio data corresponding to the speaker in the other game apparatus to the other game apparatus.

### 12

One or more non-transitory computer-readable storage media having stored therein instructions that cause one or more processors to perform operations includes
obtaining, from the game application, audio data and a plurality of volume parameters being set respectively for a plurality of audio output devices to which the game apparatus outputs the audio data,
determining an audio output target among the plurality of audio output devices,
adjusting volume of the obtained audio data based on a volume parameter corresponding to the audio output target among the plurality of volume parameters, and outputting the adjusted audio data to the audio output target, and
transmitting the audio data and the plurality of volume parameters to the other game apparatus different from the game apparatus.

One or more non-transitory computer-readable storage media (12) produces the same advantageous effects as the structure (1).

### 13

A volume adjusting method according to an aspect of the present disclosure is the volume adjusting method implementable with a game apparatus for transmitting and receiving information about a game application to and from another game apparatus by executing the game application, the method includes
obtaining, from the game application, audio data and a plurality of volume parameters being set respectively for a plurality of audio output devices to which the game apparatus outputs the audio data,
determining an audio output target among the plurality of audio output devices,
adjusting volume of the obtained audio data based on a volume parameter corresponding to the audio output target among the plurality of volume parameters, and outputting the adjusted audio data to the audio output target, and
transmitting the audio data and the plurality of volume parameters to the other game apparatus different from the game apparatus.

The method (13) produces the same advantageous effects as the structure (1).

Each of the game apparatus, the game system, the program, and the volume adjusting method according to one aspect of the present disclosure can output, to an audio output device as an audio output destination, audio with the volume corresponding to the audio output device.

Additional benefits and advantages of the disclosed embodiments will be apparent from specification and Figures. The benefits and/or advantages may be individually provided by the various embodiments and features of the specification and drawings disclosure, and need not all be provided in order to obtain one or more of the same.

### BRIEF DESCRIPTION OF THE DRAWINGS

These and other objects and features of the present disclosure will become clear from the following description taken in conjunction with the preferred embodiments thereof with reference to the accompanying drawings, in which:

FIG. 1 is a schematic external view of a game system according to an embodiment of the present disclosure;

FIG. 2 is a block diagram of the game system according to the embodiment of the present disclosure, showing the electrical configuration; and

FIG. 3 is a flowchart of an example process performed by game apparatuses according to the embodiment of the present disclosure.

### DETAILED DESCRIPTION

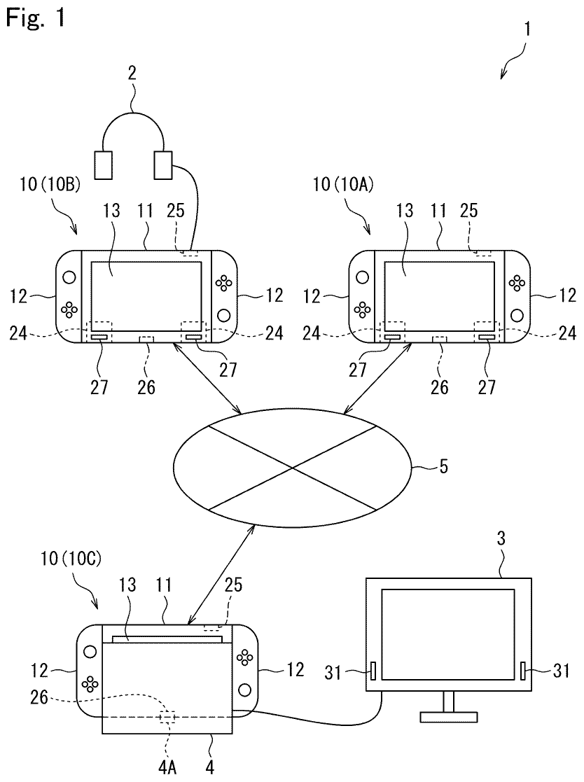

FIG. 1 is a schematic external view of a game system according to an embodiment of the present disclosure.

As shown in FIG. 1, a game system 1 according to the embodiment of the present disclosure includes multiple game apparatuses 10. In the present embodiment, the game system 1 includes three game apparatuses 10A, 10B, and 10C as the multiple game apparatuses 10. The game system 1 may include fewer or more than three game apparatuses 10.

The game apparatuses 10 are electrically connected to one another with a network 5. The game apparatuses 10 can thus transmit and receive information to and from one another. The network 5 is wired or wireless, or both, and is, for example, the Internet or a local area network (LAN).

The game apparatuses 10 may transmit and receive information directly or indirectly. For direct transmission and reception, for example, the game apparatuses 10 are wired to one another with a cable and transmit and receive information through the cable. For indirect transmission and reception, for example, the game apparatuses 10 transmit and receive information through a server including, for example, a general-purpose high-performance computer. The indirect transmission and reception also includes transmitting and receiving information through communication based on a communication standard such as Wi-Fi (registered trademark) or Bluetooth (registered trademark).

Each game apparatus 10 can execute a game application. For example, the game application is provided to the game apparatus 10 in the manner described below. For example, a storage medium such as a secure digital (SD) memory card storing a game application is installed in a card slot (not shown) included in the game apparatus 10. For example, a game application is downloaded from a server to, for example, the internal storage (not shown) or a flash memory 22 (described later) included in the game apparatus 10 through, for example, the Internet. A game application is provided to the game apparatus 10 in any of these manners, and thus the game apparatus 10 includes the game application. Although the game application may provide any game, the game may be played by multiple players in a competitive or cooperative manner.

In the game system 1 according to the present embodiment, one of the game apparatuses 10 (the game apparatus 10A in the present embodiment) includes a game application. The remaining game apparatuses 10 (the game apparatuses 10B and 10C in the present embodiment) do not include the game application. The game apparatus 10A including the game application is an example of a main apparatus. The game apparatuses 10B and 10C not including the game application are each an example of another game apparatus. The game apparatus with the game application may be the other game apparatus. For example, when all the game apparatuses 10A, 10B, and 10C include the game application, the game apparatuses 10A, 10B, and 10C may each be the main apparatus, and a game apparatus other than the main game apparatuses may be the other game apparatus.

The game apparatus 10A can transmit and receive information about the game application to and from the other game apparatuses by executing the game application. The game apparatus 10A executes the game application to transmit information about the game application to the game apparatuses 10B and 10C. The game apparatuses 10B and 10C obtain data about the game application from the game apparatus 10A, and return the results of processing performed based on the obtained data to the game apparatus 10A. Examples of the information about the game application include game images, game audio, and operation data. For example, the game apparatus 10A transmits game images and game audio to the game apparatuses 10B and 10C. The game apparatuses 10B and 10C transmit operation data (the results of the processing described above) to the game apparatus 10A.

The game application can thus be executed in all the game apparatuses 10 in the game system 1 in which one of the game apparatuses 10 includes the game application.

The configuration of each game apparatus 10 will now be described. In the present embodiment, the game apparatuses 10A, 10B, and 10C have the same configuration. The configuration of the game apparatus 10A will now be described. The configurations of the game apparatuses 10B and 10C will not be described in principle, and may be described as appropriate.

The game apparatus 10A includes a body 11 and two controllers 12 attachable to and detachable from the body 11.

The external shape of the body 11 is substantially a rectangular prism. The external shape of the body 11 is not limited to a substantially rectangular prism. The body 11 includes a display 13. The display 13 is, for example, a liquid crystal display that can display images.

The two controllers 12 are attached to the two ends of the body 11. The controllers 12 may be attached to or detached from the body 11 with known methods such as fitting, sliding, and magnetic force. The game apparatus 10A may include fewer or more than two controllers 12. The game apparatus 10A may include no controller 12.

The controllers 12 are used to operate the game apparatus 10A. The controllers 12 are electrically connected to the body 11 with wires or wirelessly. The controllers 12 include, for example, sticks and operation buttons for operations.

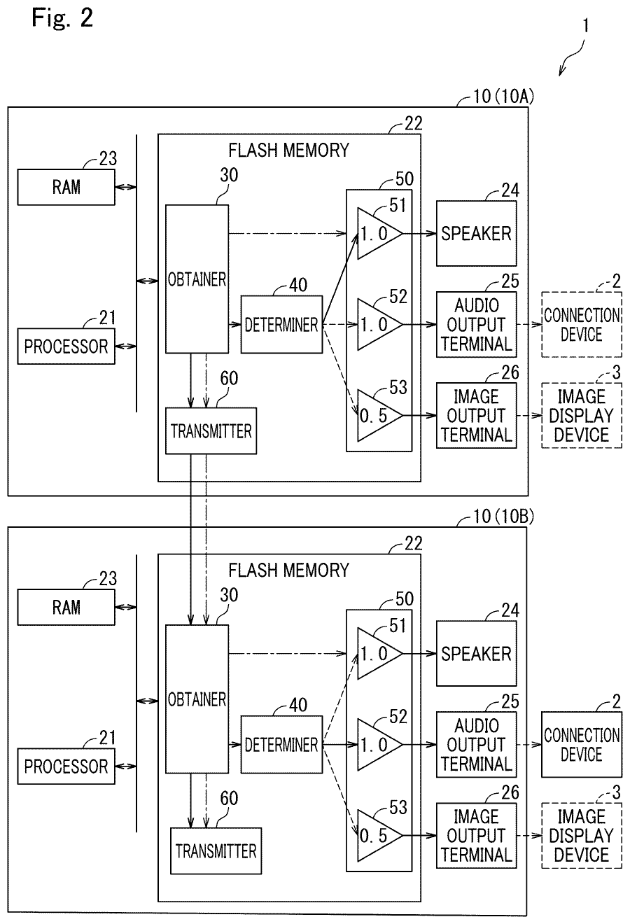

FIG. 2 is a block diagram of the game system according to the embodiment of the present disclosure, showing the electrical configuration. FIG. 2 shows the game apparatuses 10A and 10B included in the game system 1. The game apparatus 10C is not shown.

As shown in FIG. 2, the game apparatus 10A includes a processor 21, the flash memory 22, a random-access memory (RAM) 23, a speaker 24, an audio output terminal 25, and an image output terminal 26. The game apparatus 10A can output audio from various audio output devices. Examples of the audio output devices include the speaker 24, headphones, earphones, and external speakers connectable to the audio output terminal 25, and an image display device 3 (specifically, a speaker included in the image display device 3) connectable to the image output terminal 26. The game apparatus 10A may be connected to, for example, headphones, earphones, and external speakers wirelessly with Wi-Fi or Bluetooth, instead of being connected with wires through the audio output terminal 25.

The processor 21, the flash memory 22, the RAM 23, the speaker 24, the audio output terminal 25, and the image output terminal 26 are located inside the body 11. The processor 21, the flash memory 22, the RAM 23, the speaker 24, the audio output terminal 25, and the image output terminal 26 are electrically connected to one another directly or indirectly.

The processor 21 performs information processing to implement various functions of the game apparatus 10A. The processor 21 includes at least one processor such as a central processing unit (CPU), a microprocessing unit (MPU), a graphics processing unit (GPU), a digital signal processor (DSP), a field-programmable gate array (FPGA), a microcontroller unit (MCU), or an application-specific integrated circuit (ASIC).

The flash memory 22 is a nonvolatile memory. In the present embodiment, the flash memory 22 stores, for example, downloaded game applications and firmware programs. In the present embodiment, the programs stored in the firmware are executed by the processor 21 to implement an obtainer 30, a determiner 40, an adjuster 50, and a transmitter 60 (described later). The volume adjusting method according to one or more embodiments of the present disclosure is thus implementable.

The RAM 23 is a volatile memory. In the present embodiment, the RAM 23 temporarily stores, for execution, a game application and other information stored in the storage medium inserted into the card slot or in, for example, the flash memory 22. The game application is executed by the processor 21. This allows transmission and reception of the information about the game application described above.

The speaker 24 receives audio data generated through execution of the game application and outputs the audio data outside as audio. The speaker 24 is exposed outside the game apparatus 10A through an opening 27 (refer to FIG. 1) in the body 11. This allows the audio output from the speaker 24 to be output outside the game apparatus 10A. The speaker 24 is included in the audio output devices.

The audio output terminal 25 and the image output terminal 26 shown in FIGS. 1 and 2 are exposed outside the body 11.

The audio output terminal 25 can output audio data to external devices. The audio output terminal 25 is connectable to, for example, a connection device 2 such as headphones, earphones, or an external speaker. FIG. 1 shows headphones as an example of the connection device 2. The connection device 2 is included in the audio output devices.

In the present embodiment, the connection device 2 is connected to the audio output terminal 25 in the game apparatus 10B. The connection device 2 is not connected to the audio output terminal 25 in the game apparatus 10A or 10C. In FIG. 2, the connection device 2 connected to the audio output terminal 25 in the game apparatus 10B is drawn with a solid line. In FIG. 2, the connection device 2 drawn with a broken line indicates that the connection device 2 is not connected to the audio output terminal 25 in the game apparatus 10A but is connectable to the audio output terminal 25.

The image output terminal 26 can output image data and audio data to external devices. An image output device is connectable to the image output terminal 26 directly or indirectly. In the present embodiment, a cradle 4 is connected to the image output terminal 26. As described later, the image display device 3 is connectable to the cradle 4. More specifically, the image display device 3 is connectable to the image output terminal 26 with, for example, the cradle 4 or a High-Definition Multimedia interface (HDMI, registered trademark) cable for screen output. In other words, the image display device 3 is connectable to the image output terminal 26 indirectly.

The image display device 3 is, for example, an external liquid crystal display. In the present embodiment, the image display device 3 includes an internal speaker that can output audio or a connection terminal that can connect to an external speaker. The image display device 3 can output audio from the internal speaker or the external speaker. In the present embodiment, the image display device 3 is included in the audio output devices.

In the present embodiment, the image display device 3 is connected to the image output terminal 26 in the game apparatus 10C. The image display device 3 is not connected to the image output terminal 26 in either of the game apparatus 10A or the game apparatus 10B. In FIG. 2, each image display device 3 is drawn with a broken line to indicate that the image display device 3 is not connected to the image output terminal 26 in either of the game apparatus 10A or the game apparatus 10B but is connectable to the image display device 3.

As shown in FIG. 1, the cradle 4 includes a connection terminal 4A. The image output terminal 26 in each of the game apparatuses 10A, 10B, and 10C is connectable to the connection terminal 4A in the cradle 4. In FIG. 1, the image output terminal 26 in the game apparatus 10C is connected to the connection terminal 4A in the cradle 4. The image display device 3 is connectable to the cradle 4 with a terminal (not shown). The cradle 4 can thus mediate the output of image data and audio data from the game apparatus 10C to the image display device 3. In the present embodiment, the cradle 4 may function as a charger for charging the connected game apparatus 10C.

In the present embodiment, the image output terminal 26 in each of the game apparatuses 10A, 10B, and 10C and the connection terminal 4A in the cradle 4 are universal serial bus (USB, registered trademark) Type-C terminals. In the present embodiment, the terminal (not shown) in the cradle 4 to which the image display device 3 is connected is an HDMI terminal.

As described above, the programs in the firmware are executed by the processor 21 to implement the functions of the obtainer 30, the determiner 40, the adjuster 50, and the transmitter 60 shown in FIG. 2.

The obtainer 30 obtains at least audio data and multiple volume parameters from the game application stored in the RAM 23. The obtainer 30 obtains, for example, game images other than the audio data and the volume parameters.

The audio data represents the audio generated when the game application is executed.

The volume parameters are each set for the corresponding one of the audio output devices. In other words, the number of volume parameters is the number of audio output devices to which the game apparatus 10A can output the audio data. As described above, the audio output devices include the speaker 24, the connection device 2 connected to the audio output terminal 25, and the image display device 3 connected to the image output terminal 26. In the present embodiment, the volume parameters include a first parameter, a second parameter, and a third parameter. In other words, the number of volume parameters is three in the present embodiment. The first parameter is 1.0 set for the speaker 24. The second parameter is 1.0 set for a device connected to the audio output terminal 25. The third parameter is 0.5 set for the image display device 3.

The number of volume parameters is not limited to three, but is set to correspond to the number of audio output devices to which the game apparatus 10A can output the audio data. The numerical values of the volume parameters are not limited to the numerical values described above.

The game application transmits the audio data and the volume parameters to the obtainer 30 at any time. For example, for a game application that has background music (BGM) being output constantly from, for example, a speaker during execution, the game application constantly transmits the audio data to the obtainer 30. For any change in the volume parameter, for example, the game application transmits the volume parameter to the obtainer 30. The volume parameters change when, for example, a previously executed game application is stopped and a different game application is started. The game application may change the volume parameters during execution. In this case, the game application may transmit the volume parameters to the obtainer 30 during execution.

The obtainer 30 transmits the audio data to the determiner 40 and the transmitter 60 and transmits the volume parameters to the adjuster 50 and the transmitter 60. In FIG. 2, the solid arrows indicate the transmission paths for the audio data and dot-dash arrows indicate the transmission paths for the volume parameters between the obtainer 30, the determiner 40, the adjuster 50, and the transmitter 60.

The determiner 40 determines an audio output target among the audio output devices based on whether the audio output devices are connected to the game apparatus 10A. The determiner 40 may determine the audio output target among the audio output devices based on, for example, selection performed by the user of the game apparatus 10A, other than whether the audio output devices are connected to the game apparatus 10A.

In the present embodiment, the determiner 40 determines the speaker 24 as the audio output target when neither the audio output terminal 25 nor the image output terminal 26 is connected to an audio output device. When either the audio output terminal 25 or the image output terminal 26 is connected to an audio output device, the determiner 40 determines, as the audio output target, the audio output device connected to the terminal. When both the audio output terminal 25 and the image output terminal 26 are connected to audio output devices, the determiner 40 determines the audio output device connected to the audio output terminal 25 as the audio output target.

In the present embodiment, the game apparatus 10A has neither the audio output terminal 25 nor the image output terminal 26 connected to an audio output device. Thus, the determiner 40 in the game apparatus 10A determines the speaker 24 as the audio output target. FIG. 2 shows this determination using a solid arrow extending from the determiner 40 in the game apparatus 10A to the first parameter 51 in the adjuster 50 and broken arrows extending from the determiner 40 in the game apparatus 10A to the second parameter 52 and the third parameter 53 in the adjuster 50.

The determiner 40 may determine the audio output device not based on the conditions described above. When, for example, the audio output device is connected to both the audio output terminal 25 and the image output terminal 26, the determiner 40 may determine, as the audio output target, the audio output device connected to the image output terminal 26.

The adjuster 50 adjusts the volume of the audio data obtained by the obtainer 30 based on the volume parameter corresponding to the audio output target among the multiple volume parameters, and outputs the adjusted audio data to the audio output target.

For example, the adjuster 50 in the game apparatus 10A adjusts the volume of the audio data obtained by the obtainer 30 based on the first parameter 51 of 1.0 corresponding to the speaker 24 determined as the audio output target by the determiner 40. In the present embodiment, the adjuster 50 in the game apparatus 10A outputs, as the adjusted audio data, the audio data multiplied by 1 to the speaker 24.

The transmitter 60 can transmit the audio data obtained by the obtainer 30 and the volume parameters to the other game apparatuses 10B and 10C. The transmitter 60 may or may not compress the audio data and the volume parameters for transmission to the game apparatuses 10B and 10C.

The game apparatuses 10B and 10C obtain data about a game application from the game apparatus 10A to execute the game application. The game apparatuses 10B and 10C implement the functions of the obtainer 30, the determiner 40, the adjuster 50, and the transmitter 60 in the same manner as the game apparatus 10A. The obtainer 30 in each of the game apparatuses 10B and 10C obtains the audio data and the volume parameters transmitted by the transmitter 60 in the game apparatus 10A.

The game apparatus 10B has the audio output terminal 25 connected to the connection device 2. The determiner 40 in the game apparatus 10B thus determines the connection device 2 as the audio output target. FIG. 2 shows this determination using a solid arrow extending from the determiner 40 in the game apparatus 10B to the second parameter 52 in the adjuster 50 and broken arrows extending from the determiner 40 in the game apparatus 10B to the first parameter 51 and the third parameter 53 in the adjuster 50.

As shown in FIG. 1, the game apparatus 10C has the image output terminal 26 connected to the image display device 3. The determiner 40 in the game apparatus 10C thus determines the image display device 3 connected to the image output terminal 26 as the audio output target.

The adjuster 50 in the game apparatus 10B adjusts the volume of the audio data obtained by the obtainer 30 based on the second parameter of 1.0 corresponding to the connection device 2 as the audio output target determined by the determiner 40. In the present embodiment, the adjuster 50 in the game apparatus 10B outputs, as the adjusted audio data, the audio data multiplied by 1 to the connection device 2 connected to the audio output terminal 25.

The adjuster 50 in the game apparatus 10C adjusts the volume of the audio data obtained by the obtainer 30 based on the third parameter of 0.5 corresponding to the image display device 3 connected to the image output terminal 26 determined as the audio output target by the determiner 40. In the present embodiment, the adjuster 50 in the game apparatus 10C outputs, as the adjusted audio data, the audio data multiplied by 0.5 to the image display device 3.

The transmitter 60 in each of the game apparatuses 10B and 10C does not transmit the audio data and the volume parameters to other game apparatuses. When each of the game apparatuses 10B and 10C includes the game application (in other words, when the game apparatuses 10B and 10C are each a main apparatus), the transmitter 60 in each of the game apparatuses 10B and 10C can transmit the audio data and the volume parameters to the other game apparatuses, similarly to the transmitter 60 in the game apparatus 10A. When the game apparatus 10A does not include the game application (in other words, when the game apparatus 10A is not a main apparatus), the game apparatus 10A does not transmit the audio data and the volume parameters from the transmitter 60 to the other game apparatuses.

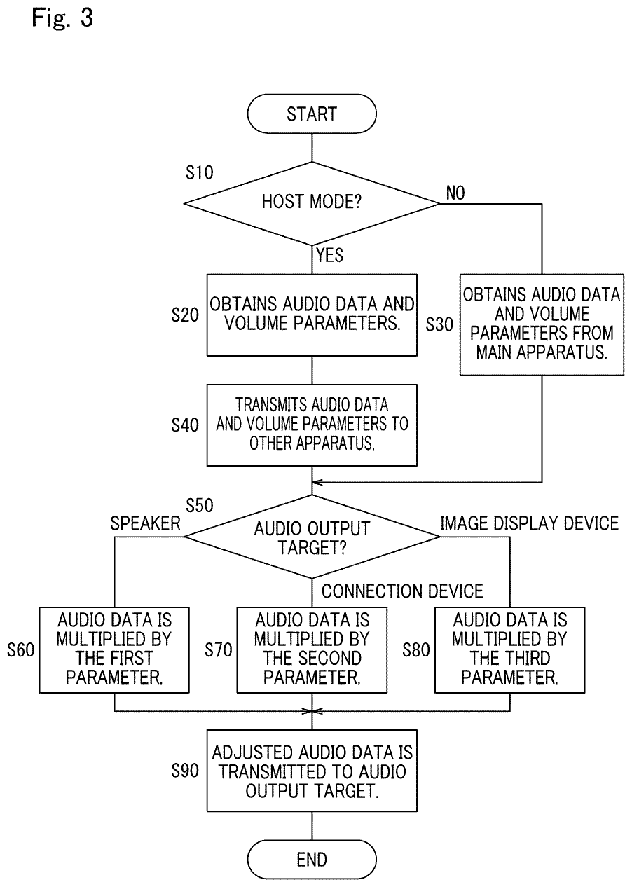

FIG. 3 is a flowchart of an example process performed by the game apparatuses according to the embodiment of the present disclosure.

An example volume adjusting method implemented by the game apparatus 10A will now be described with reference to FIG. 3.

The game apparatus 10A including a game application executes the game application. The user of the game apparatus 10A selects, in the executed game application, a host mode or a secondary mode (S10) to execute the game application. The selection is performed on, for example, a selection menu displayed on the display 13 by the game application. In this example, the host mode is selected, and the game application is executed in the host mode (Yes in S10). More specifically, the game apparatus 10A is a main apparatus. The obtainer 30 thus obtains the audio data and the volume parameters from the game application (S20). The obtainer 30 transmits the obtained audio data to the determiner 40 and the obtained volume parameters to the adjuster 50. In this example, the game apparatus 10A operates in the host mode. In another example, the game apparatus 10A may operate in the secondary mode.

The transmitter 60 in the game apparatus 10A then transmits the audio data and the volume parameters to the other game apparatuses 10B and 10C (S40).

The determiner 40 determines the audio output target (S50). In the present embodiment, the determiner 40 determines the speaker 24 as the audio output target.

The adjuster 50 multiplies the audio data transmitted from the obtainer 30 by 1.0 as the first parameter 51 (S60), and transmits the multiplied adjusted audio data to the speaker 24 as the audio output target (S90). This causes the speaker 24 in the game apparatus 10A to output audio with the volume corresponding to the adjusted audio data.

An example process performed by the game apparatus 10B will now be described with reference to FIG. 3.

The game apparatus 10B not including the game application executes the game application in response to transmission of information about the game application from the game apparatus 10A operating in the host mode. The user of the game apparatus 10B selects, in the executed game application, the host mode or the secondary mode to execute the game application (S10). In this example, the secondary mode is selected, and the game application is executed in the secondary mode (No in S10). More specifically, the game apparatus 10B is one of the other devices. The game apparatus 10B may automatically operate in the secondary mode when the information about the game application is transmitted from the game apparatus 10A operating in the host mode.

The obtainer 30 in the game apparatus 10B obtains the audio data and the volume parameters transmitted from the transmitter 60 in the game apparatus 10A (S30). The obtainer 30 transmits the obtained audio data to the determiner 40 and the obtained volume parameters to the adjuster 50.

The game apparatus 10B is one of the other game apparatuses (No in S10). The transmitter 60 in the game apparatus 10B thus does not transmit the audio data and the volume parameters to the other game apparatuses 10A and 10C. In other words, step S40 is not performed.

The determiner 40 determines the audio output target (S50). In the present embodiment, the determiner 40 determines the connection device 2 connected to the audio output terminal 25 as the audio output target.

The adjuster 50 multiplies the audio data transmitted from the obtainer 30 by 1.0 as the second parameter 52 (S70) and transmits the multiplied adjusted audio data to the connection device 2 connected, as the audio output target, to the audio output terminal 25 (S90). This causes the connection device 2 to output audio with the volume corresponding to the adjusted audio data.

An example process performed by the game apparatus 10C will now be described with reference to FIG. 3.

The game apparatus 10C not including the game application executes the game application in response to transmission of information about the game application from the game apparatus 10A operating in the host mode. The user of the game apparatus 10C selects, in the executed game application, the host mode or the secondary mode to execute the game application (S10). In this example, the secondary mode is selected, and the game application is executed in the secondary mode (No in S10). More specifically, the game apparatus 10C is one of the other game apparatuses. The game apparatus 10C may automatically operate in the secondary mode when the information about the game application is transmitted from the game apparatus 10A operating in the host mode.

The obtainer 30 in the game apparatus 10C obtains the audio data and the volume parameters transmitted from the transmitter 60 in the game apparatus 10A (S30). The obtainer 30 transmits the obtained audio data to the determiner 40 and the obtained volume parameters to the adjuster 50.

The game apparatus 10C is one of the other game apparatuses (No in S10). The transmitter 60 in the game apparatus 10C thus does not transmit the audio data and the volume parameters to the other game apparatuses 10A and 10B. In other words, step S40 is not performed.

The determiner 40 determines the audio output target (S50). In the present embodiment, the determiner 40 determines the image display device 3 connected to the image output terminal 26 as the audio output target.

The adjuster 50 multiplies the audio data transmitted from the obtainer 30 by 0.5 as the third parameter 53 (S80) and transmits the multiplied adjusted audio data to the image display device 3 as the audio output target (S90). This causes the image display device 3 to output audio with the volume corresponding to the adjusted audio data.

The transmitter 60 may convert the audio data and the volume parameters for transmission to the game apparatuses 10B and 10C. For example, when the speaker 24 included in the game apparatus 10A is of the type different from the type of the speaker 24 included in the game apparatus 10B, the transmitter 60 in the game apparatus 10A may transmit, to the game apparatus 10B, the audio data converted to the format matching the format of the speaker 24 included in the game apparatus 10B. In the above example, the game apparatus 10A may identify the type of speaker 24 included in the game apparatus 10B by referring to apparatus information (e.g., information about the model of the game apparatus 10B or information about a device connectable to the game apparatus 10B) obtained from the game apparatus 10B. In this manner, the transmitter 60 in the game apparatus 10A may convert, for transmission to another game apparatus, the audio data obtained by the obtainer 30 to data corresponding to the other game apparatus based on apparatus information obtained from the other game apparatus.

The game apparatus 10A may handle image data and multiple image parameters in addition to the audio data and the volume parameters.

The game apparatus 10A may handle image data and multiple image parameters in place of the audio data and the volume parameters.

More specifically, the game apparatus is a game apparatus for transmitting and receiving information about a game application to and from another game apparatus by executing the game application. The game apparatus includes an obtainer that obtains, from the game application, image data and a plurality of image parameters being set respectively for a plurality of image output devices to which the game apparatus outputs the image data, a determiner that determines an image output target among the plurality of image output devices, an adjuster that adjusts the image data obtained by the obtainer based on an image parameter corresponding to the image output target among the plurality of image parameters, and outputs the adjusted image data to the image output target, and a transmitter that transmits the image data and the plurality of image parameters obtained by the obtainer to the other game apparatus.

The obtainer 30 may obtain the image data and the image parameters from the game application.

The image data represents images generated in response to execution of the game application.

The image parameters are set for the respective image output devices to which the game apparatus 10A can output the image data. More specifically, the number of image parameters is the number of image output devices to which the game apparatus 10A can output the image data. The image output devices are, for example, the display 13 included in the game apparatus 10A and the image display device 3 connected to the image output terminal 26. In this case, the volume parameters are two volume parameters. One of the two parameters is set for the display 13. The other parameter is set for the image display device 3. For example, when the display 13 has high dynamic range (HDR) capability whereas the image display device 3 does not, one parameter widens the dynamic range of image data whereas the other parameter maintains the dynamic range of image data.

The determiner 40 may determine the image output target among the multiple image output devices based on whether the image output devices are connected to the game apparatus 10A. The determiner 40 may determine the image output target among the multiple image output devices based on, for example, selection performed by the user of the game apparatus 10A, other than whether the image output devices are connected to the game apparatus 10A.

When the image display device 3 is not connected to the image output terminal 26, for example, the determiner 40 determines the display 13 as the image output target. When the image display device 3 is connected to the image output terminal 26, for example, the determiner 40 determines the image display device 3 as the image output target.

The adjuster 50 may adjust the image data obtained by the obtainer 30 based on the image parameters corresponding to the image output target among the multiple image parameters, and output the adjusted image data to the image output target. The image data is adjusted by, for example, multiplying the image data by the image parameters or converting the format of the image data based on the image parameters.

The transmitter 60 can transmit the image data and the image parameters obtained by the obtainer 30 to the other game apparatuses 10B and 10C.

The game apparatus 10A may handle waveform data and multiple waveform parameters in addition to the audio data and the volume parameters.

The game apparatus 10A may handle waveform data and multiple waveform parameters in place of the audio data and the volume parameters.

More specifically, the game apparatus is a game apparatus for transmitting and receiving information about a game application to and from another game apparatus by executing the game application. The game apparatus includes an obtainer that obtains, from the game application, waveform data about vibration of the game apparatus and a plurality of waveform parameters being set respectively for a plurality of waveform output devices to which the game apparatus outputs the waveform data, a determiner that determines a waveform output target among the plurality of waveform output devices, an adjuster that adjusts the waveform data obtained by the obtainer based on a waveform parameter corresponding to the waveform output target among the plurality of waveform parameters, and outputs the adjusted waveform data to the waveform output target, and a transmitter that transmits the waveform data and the plurality of waveform parameters obtained by the obtainer to the other game apparatus.

The obtainer 30 may obtain the waveform data and the waveform parameters from the game application.

The waveform data is data about vibrations generated in the game apparatus 10A in response to execution of the game application. For example, larger amplitude in the waveform data causes the game apparatus 10A to vibrate more strongly, and higher frequencies of the vibrations in the waveform data increase the vibration rate of the game apparatus 10A per unit time.

The waveform parameters are set for the respective waveform output devices to which the game apparatus 10A can output the waveform data. More specifically, the number of waveform parameters is the number of waveform output devices to which the game apparatus 10A can output the waveform data. The waveform output devices are, for example, the controllers 12 included in the game apparatus 10A and the connection device 2 connected to the audio output terminal 25. In this case, the waveform parameters are two waveform parameters. One of the two parameters is set for, for example, the amplitude value or the frequency value corresponding to the controllers 12. The other parameter is set for, for example, the amplitude value or the frequency value corresponding to the connection device 2 connected to the audio output terminal 25.

The determiner 40 may determine the waveform output target among the waveform output devices based on whether the waveform output devices are connected to the game apparatus 10A. The determiner 40 may determine the waveform output target among the waveform output devices based on, for example, selection performed by the user of the game apparatus 10A, other than whether the waveform output devices are connected to the game apparatus 10A.

For example, when the connection device 2 is not connected to the audio output terminal 25, the determiner 40 determines the controllers 12 as waveform output targets. When the connection device 2 is connected to the audio output terminal 25, the determiner 40 determines both the controllers 12 and the connection device 2 as waveform output targets.

The adjuster 50 may adjust the waveform data obtained by the obtainer 30 based on the waveform parameter corresponding to the waveform output target among the multiple waveform parameters, and output the adjusted waveform data to the waveform output target. The waveform data is adjusted by, for example, changing the amplitude of the waveform data based on the amplitude value or changing the frequency of the waveform data based on the frequency value.

The transmitter 60 can transmit the waveform data and the waveform parameters obtained by the obtainer 30 to the other game apparatuses 10B and 10C.

In the above embodiment, the game apparatuses 10A, 10B, and 10C have the same configuration, but may have different configurations. For example, the game apparatus 10A may be the successor to the game apparatuses 10B and 10C. For example, the game apparatuses 10A and 10B and the game apparatus 10C may be different types of game-specific consoles released by different companies. In the above embodiment, the game apparatuses 10A, 10B, and 10C are game-specific consoles, but are not limited to game-specific consoles. For example, at least one of the game apparatuses 10A, 10B, and 10C may be a general-purpose machine such as a personal computer or a smartphone that can perform operations other than games.

Although the main apparatus (game apparatus 10A) operating in the host mode includes the game application in the above embodiment, the structure is not limited to this embodiment. For example, a server including, for example, a general-purpose high-performance computer may include a game application, as in online games. The server may transmit audio data and volume parameters to multiple game apparatuses 10 (e.g., the game apparatuses 10A, 10B, and 10C) as appropriate.

The embodiments and modifications described above may be combined as appropriate to produce their advantageous effects.

What is claimed is:

1. A game apparatus for transmitting and receiving information about a game application to and from another game apparatus by executing the game application, the apparatus comprising:
an obtainer configured to obtain, from the game application, audio data and a plurality of volume parameters being set respectively for a plurality of audio output devices to which the game apparatus outputs the audio data;
a determiner configured to determine an audio output target among the plurality of audio output devices;
an adjuster configured to adjust a volume of the audio data obtained by the obtainer based on a volume parameter corresponding to the audio output target among the plurality of volume parameters, and output the adjusted audio data to the audio output target; and
a transmitter configured to transmit the audio data and the plurality of volume parameters obtained by the obtainer to the other game apparatus.

2. The game apparatus according to claim 1, further comprising:
a speaker; and
an audio output terminal configured to output audio,
wherein the plurality of audio output devices include the speaker and a connection device connected to the audio output terminal, and
the plurality of volume parameters include a first parameter corresponding to the speaker and a second parameter corresponding to the connection device.

3. The game apparatus according to claim 1, further comprising:
a speaker; and
an image output terminal configured to output audio and an image,
wherein the plurality of audio output devices include the speaker and an image display device connected to the image output terminal, and
the plurality of volume parameters include a first parameter corresponding to the speaker and a third parameter corresponding to the image display device.

4. The game apparatus according to claim 1, wherein
the transmitter converts the audio data obtained by the obtainer to data corresponding to the other game apparatus based on apparatus information obtained from the other game apparatus and transmits the converted audio data to the other game apparatus.

5. The game apparatus according to claim 1, wherein
the obtainer obtains, from the game application, image data and a plurality of image parameters being set respectively for a plurality of image output devices to which the game apparatus outputs the image data,
the determiner determines an image output target among the plurality of image output devices,
the adjuster adjusts the image data obtained by the obtainer based on an image parameter corresponding to the image output target among the plurality of image parameters, and outputs the adjusted image data to the image output target, and
the transmitter transmits the image data and the plurality of image parameters obtained by the obtainer to the other game apparatus.

6. The game apparatus according to claim 1, wherein
the obtainer obtains, from the game application, waveform data about vibrations of the game apparatus and a plurality of waveform parameters being set respectively for a plurality of waveform output devices to which the game apparatus outputs the waveform data,
the determiner determines a waveform output target among the plurality of waveform output devices,
the adjuster adjusts the waveform data obtained by the obtainer based on a waveform parameter corresponding to the waveform output target among the plurality of waveform parameters, and outputs the adjusted waveform data to the waveform output target, and
the transmitter transmits the waveform data and the plurality of waveform parameters obtained by the obtainer to the other game apparatus.

7. A game system, comprising:
a plurality of game apparatuses configured to execute a game application and transmit and receive information to and from one another, each of the plurality of game apparatuses including
an obtainer configured to obtain audio data and a plurality of volume parameters being set respectively for a plurality of audio output devices to which the plurality of game apparatuses output the audio data,
a determiner configured to determine an audio output target among the plurality of audio output devices,
an adjuster configured to adjust a volume of the audio data obtained by the obtainer based on a volume parameter corresponding to the audio output target among the plurality of volume parameters, and output the adjusted audio data to the audio output target, and
a transmitter configured to transmit the audio data and the plurality of volume parameters to another game apparatus of the plurality of game apparatuses,
the obtainer in a main apparatus being one of the plurality of game apparatuses including the game application, the obtainer in a main apparatus being configured to obtain the audio data and the plurality of volume parameters from the game application, and
the obtainer in a game apparatus of the plurality of game apparatuses other than the main apparatus being configured to obtain at least the audio data and the plurality of volume parameters transmitted by the transmitter in the main apparatus.

8. The game system according to claim 7, wherein
each of the plurality of game apparatuses includes
a speaker, and
an audio output terminal configured to output audio,
the plurality of audio output devices include the speaker and a connection device connected to the audio output terminal, and
the plurality of volume parameters include a first parameter corresponding to the speaker and a second parameter corresponding to the connection device.

9. The game system according to claim 7, wherein
each of the plurality of game apparatuses includes
a speaker, and
an image output terminal configured to output audio and an image,
the plurality of audio output devices include the speaker and an image display device connected to the image output terminal, and
the plurality of volume parameters include a first parameter corresponding to the speaker and a third parameter corresponding to the image display device.

10. The game system according to claim 7, wherein
the game apparatus other than the main apparatus does not include the game application, and obtains a game image associated with the game application from the main apparatus.

11. The game system according to claim 7, wherein
the transmitter in the main apparatus converts the audio data to data corresponding to the game apparatus other than the main apparatus based on apparatus information obtained from the game apparatus other than the main apparatus, and transmits the converted audio data to the game apparatus other than the main apparatus.

12. One or more non-transitory computer-readable storage media having stored therein instructions that cause one or more processors to perform operations comprising:
obtaining, from the game application, audio data and a plurality of volume parameters being set respectively for a plurality of audio output devices to which the game apparatus outputs the audio data;
determining an audio output target among the plurality of audio output devices;
adjusting volume of the obtained audio data based on a volume parameter corresponding to the audio output target among the plurality of volume parameters, and outputting the adjusted audio data to the audio output target; and
transmitting the audio data and the plurality of volume parameters to the other game apparatus different from the game apparatus.

13. A volume adjusting method implementable with a game apparatus for transmitting and receiving information about a game application to and from another game apparatus by executing the game application, the method comprising:
obtaining, from the game application, audio data and a plurality of volume parameters being set respectively for a plurality of audio output devices to which the game apparatus outputs the audio data;
determining an audio output target among the plurality of audio output devices;
adjusting volume of the obtained audio data based on a volume parameter corresponding to the audio output target among the plurality of volume parameters, and outputting the adjusted audio data to the audio output target; and
transmitting the audio data and the plurality of volume parameters to the other game apparatus different from the game apparatus.
